(19) United States
(12) Patent Application Publication
(10) Pub. No.: US 2019/0019074 A1
(43) Pub. Date: Jan. 17, 2019

(54) Wireless Tags With Printed Stud Bumps, and Methods of Making and Using the Same

(71) Applicants: Mao TAKASHIMA, Cupertino, CA (US); Junfeng MEI, Sunnyvale, CA (US)

(72) Inventors: Mao TAKASHIMA, Cupertino, CA (US); Junfeng MEI, Sunnyvale, CA (US); Joey LI, Milpitas, CA (US)

(73) Assignee: Thin Film Electronics ASA, Norway (NO)

(21) Appl. No.: 15/750,481

(22) PCT Filed: Aug. 5, 2016
(86) PCT No.: PCT/US16/45900

§ 371 Date: Feb. 5, 2018

Related U.S. Application Data
(60) Provisional application No. 62/202,025, filed on Aug. 6, 2015.

(51) Int. Cl. G06K 19/077; H01Q 1/22

(52) U.S. Cl. CPC G06K 19/0775; H01Q 1/2225; G06K 19/07775; H01Q 1/2283; G06K 19/07786

(57) ABSTRACT

A wireless (e.g., near field or RF) communication device, and methods of manufacturing the same are disclosed. The method of manufacturing the wireless communication device includes forming an integrated circuit on a first substrate, printing stud bumps on input and/or output terminals of the integrated circuit, forming an antenna on a second substrate, and electrically connecting ends of the antenna to the stud bumps. The antenna is configured to (i) receive and (ii) transmit or broadcast wireless signals.

### CROSS REFERENCE TO RELATED APPLICATION

This application claims the benefit of U.S. Provisional Pat. Appl. No. 62/202,025, filed on Aug. 6, 2015, incorporated herein by reference as if fully set forth herein.

### FIELD OF THE INVENTION

The present invention generally relates to the field(s) of wireless communications and wireless devices. More specifically, embodiments of the present invention pertain to radio frequency (RF and/or RFID), near field communication (NFC), high frequency (HF), very high frequency (VHF), ultra high frequency (UHF), and electronic article surveillance (EAS) tags and devices with printed stud bumps for attaching and/or connecting antennas to electrical circuitry in the tags/devices, and methods of manufacturing and using the same.

### DISCUSSION OF THE BACKGROUND

Conventional gold wire bumps on a radio frequency bar code (RFBC) or an electronic article surveillance (EAS) inlay may be attached to an antenna. Conventional gold wire bumping is an inlay-level process having a relatively slow throughput. Generally, large numbers of bonding machines are required for mass volume production using gold wire bumping. RFBC and EAS tags and/or devices are consumable products, typically manufactured on the scale of billions of devices per year. Manufacturing one sheet of inlay substrates (e.g., on the order of several thousand substrates) using gold wire bumping takes approximately 1.5 to 2 hours. As a result, a bumping process with high throughput is desired for increasing the scalability of the manufacturing process.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to wireless communications and wireless devices. More specifically, embodiments of the present invention pertain to radio frequency (RF and/or RFID), near field communication (NFC), high frequency (HF), very high frequency (VHF), or ultra high frequency (UHF), and electronic article surveillance (EAS) tags and devices with printed stud bumps, and methods of manufacturing the same.

In one aspect, the present invention relates to a method of manufacturing a device configured for wireless communication, comprising forming an integrated circuit on a first substrate, printing stud bumps on input and/or output terminals of the integrated circuit, forming an antenna on a second substrate, and electrically connecting ends of the antenna to the stud bumps. The antenna is configured to (i) receive and (ii) transmit or broadcast wireless signals. The integrated circuit is configured to (i) process the received wireless signals and/or information therefrom, and (ii) generate the wireless signals to be transmitted or broadcast (and/or information therefor).

In another aspect, the present invention relates to a wireless (e.g., near field or RF) communication device, comprising a first substrate, an integrated circuit (IC) on the first substrate, printed stud bumps on input and/or output terminals of the integrated circuit, a second substrate, and an antenna on the second substrate, wherein the antenna is electrically connected to the printed stud bumps. The integrated circuit is configured to (i) process a first wireless signal and/or information from the first wireless signal, and (ii) generate a second wireless signal and/or information for the second wireless signal. The antenna is configured to receive the first wireless signal and transmit or broadcast the second wireless signal.

Sheet-level printed bumps solve the problem(s) with the conventional gold bumping process. For example, in a conventional gold bumping process that takes 1.5 to 2 hours, the same pattern of printed stud bumps on the same substrate can be formed (e.g., from a self-aligning adhesive and solder) in as short a time as 10 to 20 minutes. The process also significantly reduces the cost of the bumps. As a result, the present invention reduces the cost and processing time of wireless tags, and increases the scalability of the manufacturing process. These and other advantages of the present invention will become readily apparent from the detailed description of various embodiments below.

### BRIEF DESCRIPTION OF THE DRAWINGS

FIG. 1 shows a flow chart for an exemplary process for making wireless devices (e.g., NFC/RF tags) using printed stud bumps, in accordance with one or more embodiments of the present invention.

FIGS. 2A-2C show cross-sectional views of exemplary intermediates in the exemplary process, and FIG. 2D shows a cross-sectional view of an exemplary wireless tag with printed stud bumps, in accordance with one or more embodiments of the present invention.

FIGS. 3A-3B show cross-sectional views of exemplary stud bump structures in accordance with one or more embodiments of the present invention.

FIG. 4 is a photograph of an exemplary printed stud bump, in accordance with an embodiment of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and materials have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The present invention solves one or more problems in conventional solutions that use conventional gold wire bumping, which requires numerous bonding machines and expensive bump material(s), and has relatively slow throughput. The present invention advantageously reduces the cost and processing time of wireless tags and increases the scalability of the manufacturing process. In addition, the present invention process also significantly reduces the cost of processing the bumps.

### An Exemplary Method of Making a Wireless Communication Device

The present invention concerns a method of manufacturing a wireless communication device, comprising forming an integrated circuit on a first substrate, printing stud bumps on input and/or output terminals of the integrated circuit, forming an antenna on a second substrate, and electrically connecting ends of the antenna to the stud bumps. The integrated circuit is configured to (i) process a first wireless signal and/or information from the first wireless signal, and (ii) generate a second wireless signal and/or information for the second wireless signal. The antenna is configured to receive and/or transmit or broadcast a wireless signal. In various embodiments, the wireless communications and wireless devices comprises radio frequency (RF and/or RFID), near field communication (NFC), high frequency (HF), very high frequency (VHF), or ultra high frequency (UHF), and electronic article surveillance (EAS) tags and devices. In one example, the device is an NFC device, such as an NFC tag.

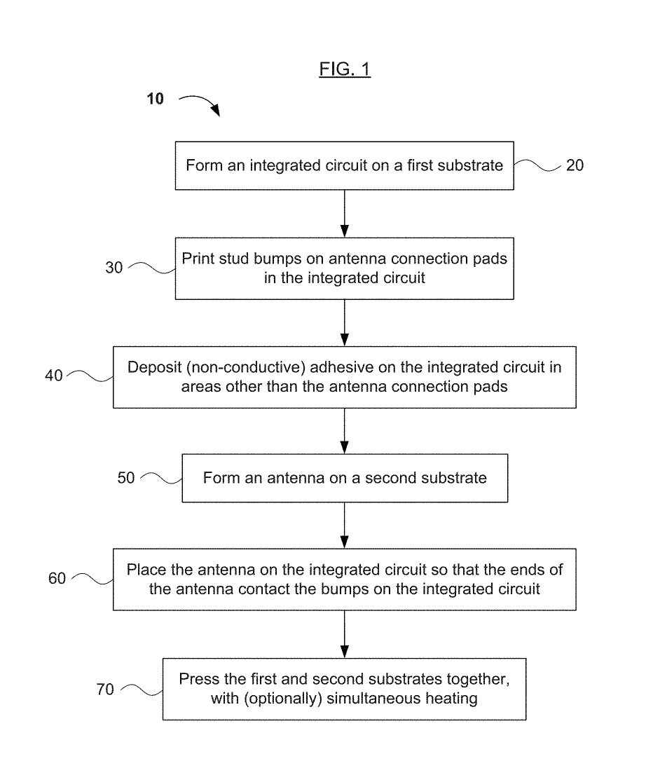

FIG. 1 shows a flow chart for an exemplary process 10 for making wireless devices (e.g., NFC/RF tags) using printed stud bumps, in accordance with one or more embodiments of the present invention. At 20, an integrated circuit is formed on a first substrate. Forming the integrated circuit may comprise printing one or more layers of the integrated circuit. In an exemplary method, a plurality of the layers of the integrated circuits may be printed, in which a lowermost layer (e.g., a lowermost insulator, conductor, or semiconductor layer may be printed on the first substrate. Printing offers advantages over photolithographic patterning processes, such as low equipment costs, greater throughput, reduced waste (and thus, a “greener” manufacturing process), etc., which can be ideal for relatively low transistor-count devices such as NFC, RF and HF tags.

Alternatively, the method may form one or more layers of the integrated circuit by one or more thin film processing techniques. Thin film processing also has a relatively low cost of ownership, and is a relatively mature technology, which can result in reasonably reliable devices being manufactured on a wide variety of possible substrates. Thus, in some embodiments, the method may comprise forming a plurality of layers of the integrated circuitry by thin-film processing techniques (e.g., blanket deposition, photolithographic patterning, etching, etc.).

In some embodiments, the best of both approaches can be used, and the method may comprise forming one or more layers of the integrated circuit by thin film processing, and printing one or more additional layers of the integrated circuit. In some embodiments, a plurality of integrated circuits may be formed on the first substrate. Additionally, the plurality of integrated circuits may be formed in an array of rows and columns on the first substrate.

In various embodiments, the first substrate may comprise a plastic, glass, or metal sheet, film or foil, or a laminate thereof. For example, a metal substrate may comprise a metal foil, such as a stainless steel foil. Alternatively, the first substrate may comprise a plastic film (e.g., polyethylene terephthalate [PET] or polyimide) or a glass sheet or slip (e.g., silicate glass, which may be coated with one or more protective and/or anti-reflective films, and which may be used in or for one or more display applications).

Additionally, input and/or output terminals may be formed in an uppermost metal layer of the integrated circuit. In exemplary embodiments, the input and/or output terminals comprise first and second antenna connection pads. The antenna connection pads may be formed in or on the integrated circuit, preferably in the uppermost metal layer of the integrated circuit. The material of the antenna connection pads may include aluminum, tungsten, copper, silver, etc., or a combination thereof (e.g., a tungsten thin film on an aluminum pad).

At 30, stud bumps are printed on the input and/or output terminals (e.g., on the antenna connection pads). A stud bump material may be printed on the input and/or output terminals (e.g., the metal antenna connection pads) of an inlay substrate. Typically, a first stud bump is printed on a first input and/or output terminal, and a second stud bump is printed on a second input and/or output terminal. In some embodiments, the first input and/or output terminal is at a first end of the integrated circuit, and the second input and/or output terminal is at a second end of the integrated circuit opposite from the first end. Such an arrangement enables the first substrate and integrated circuit to function as a strap to connect the ends of a single layer antenna.

Printing the stud bump material may comprise screen printing, stencil printing, gravure printing, or flexographic printing. The stud bump material may include or comprise a solder and a resin (e.g., an adhesive resin). Some materials that include both a solder alloy and a resin may be referred to as “self-alignment adhesive with solder,” or SAAS. One such SAAS resin is a SAM resin ([e.g., SAM10 resin, available from Tamura Corporation, Osaka, JP; this and/or other SAAS and/or SAM resins are available from Panasonic Corporation, Tokyo, JP; Namics Corporation, Niigata City, JP; and Nagase & Co., Ltd., Tokyo, JP). Such resins are designed to assemble small electrical devices, and can simultaneously form a conductive bump and an adhesive on the substrate for securing the bump to the substrate. This enables the manufacturer to skip multiple steps of processing (e.g., printing the solder, reflowing the solder, cleaning the board, attaching the bumps to the board, and encapsulating or securing the bump with an epoxy). In various embodiments, the solder alloy comprises tin and one or more alloying elements selected from bismuth, silver, copper, zinc, and indium. In general, the resin comprises an epoxy resin (e.g., that is activated by heating, generally to the solder reflow temperature or less).

Additionally, the solder alloy and resin material may be heated to form the stud bumps. The printed stud bump material may be heated in an oven or furnace at a temperature effective to segregate the solder and the adhesive or resin, and to reflow the solder. In some embodiments, a substrate sheet of integrated circuits including printed solder alloy and resin material on the antenna connection pads may be heated in a reflow furnace at a peak temperature of 250° C. for four minutes. During the reflow process, the solder in the printed solder and resin material, which is printed in a bump or conical shape, melts and balls up, while the resin settles and covers a lowermost portion (e.g., half) of the solder ball. Thus, heating the material (e.g., the solder alloy and resin) may expose an upper portion of the reflowed solder ball.

The present stud bump printing process advantageously takes approximately 10 to 20 minutes to carry out on a sheet of several thousand integrated circuits, especially when using a screen printer and a belt furnace for reflowing the solder/resin material. Typically, a lower resistance of the stud bump material after attachment to the antenna indicates higher quality contacts, which is especially important in EAS tags/devices. For example, a Q factor of about 30 to about 90 (e.g., about 60 or any other value or range of values therein) in an EAS tag/device indicates that contact between the bumps and the antenna is relatively good. Thus, in some embodiments, the method may further comprise forming an underbump layer on the input and/or output terminals (e.g., the antenna connection pads) prior to printing the stud bumps. The underbump layer generally helps to prevent formation of an oxide on the material that forms the input and/or output terminals (e.g., the antenna pads). The underbump layer may comprise one or more conductive and/or metal layers (e.g., Cu, Ni, Pd, Au, graphene, carbon nanotubes, etc.) that are resistant to forming an oxide (e.g., in air having a relative humidity or 50% or less, at 25° C. and 1 atm pressure). The underbump layer may be formed by printing (as described herein), plating (e.g., electroplating or electroless plating), sputtering and patterning, etc. When the underbump layer comprises Au, the Au may dissolve into the solder in the stud bump.

After printing and reflowing, the stud bumps may have a predetermined size and/or shape. For example, the stud bumps may have a thickness of 10 to 1000 μm (e.g., 50-500 μm or any value or range of values therein, such as 100 μm) and a diameter of 25 to 2000 μm (e.g., 100-1500 μm or any value or range of values therein, such as 300 μm) at half of the height (or thickness) of the bumps. The resin may have a radius at the base of the stud bump of 50 to 5000 μm (e.g., 200-3000 μm or any value or range of values therein, such as 600 μm). For example, when screen printed, such stud bumps can be formed when the screen has holes or openings for the stud bumps with a radius of 20 to 2000 μm (e.g., 80-1200 μm or any value or range of values therein, such as 250 μm).

At 40, an adhesive may be deposited on the integrated circuit in areas other than the antenna connection pads. A non-conductive adhesive may be used for this purpose. Typically, the adhesive is dispensed on the bump side of the inlay. In various embodiments, the non-conductive adhesive may be an epoxy adhesive.

Integrated circuits in an array on a sheet of substrates (e.g., a stainless steel sheet) are diced or singulated to form first substrates to place into each inlay. The adhesive can be formed on each integrated circuit before or after dicing and/or placing into the inlay.

At 50, an antenna is formed on a second substrate (e.g., a PET film). The antenna may be formed by depositing a metal onto the second substrate, patterning the metal (e.g., by conventional photolithography), and etching the patterned metal layer. In some embodiments, forming the antenna may consist of forming a single metal layer on the second substrate, patterning the metal layer, and etching the single metal layer to form the antenna. Alternatively, forming the antenna may comprise printing a metal ink on the second substrate in a pattern corresponding to the antenna. Additionally and/or alternatively, a bulk metal may be electroplated or electrolessly plated on the printed metal ink. An exemplary antenna thickness for HF devices may be about 20 μm to 50 μm (e.g., about 30 μm), and may be about 10 μm to about 30 μm (e.g., about 20 μm) for UHF devices.

In some embodiments, the antenna consists of a single metal layer on the second substrate, and the IC is formed or made on the first substrate in a manner enabling the IC to function as a strap or bridge between the terminals of the antenna, and thus electrically connect the terminals of the antenna to the IC. In such embodiments, the printed stud bumps are in locations on the integrated circuit that corresponding to ends of the antenna, and the integrated circuit is covered with an insulator (and optionally, an epoxy non-conductive adhesive) in areas other than the printed stud bumps. This allows for use of an antenna that consists of a single patterned metal layer.

Subsequently, the solder and resin is pressed into the antenna metal to form a contact between the antenna and the stud bump. For example, at 60, the antenna is placed on the integrated circuit so that the ends of the antenna contact the bumps on the integrated circuit. The antenna is placed on or over the integrated circuit, so that the first end of the antenna contacts the first stud bump on the integrated circuit, and the second end of the antenna contacts the second stud bump on the integrated circuit. Typically, the antenna and integrated circuit are placed face-to-face, but alternatively, holes can be formed in the second substrate exposing ends of the antenna, and the second substrate can function as an (extra) insulator between the antenna and integrated circuit. In some embodiments, the inlay and antenna may be secured with additional adhesive (e.g., epoxy).

At 70, the first and second substrates are pressed together after placing the antenna on or over the integrated circuit, such that the stud bumps and the ends of the antenna being pressed together form contacts between the antenna and the printed stud bumps, while adhesion between the inlay (e.g., integrated circuit) and the antenna is secured (e.g., with additional epoxy or other non-conductive adhesive). The stud bumps form an indent on (i.e., providing ohmic contact with) the antenna, particularly an antenna comprising aluminum, while the adhesive adheres the inlay to the antenna.

Pressure may be applied using a conventional bonder (e.g., available from Muhlbauer High Tech International, Roding, Germany) at a pressure of about 0.1N to about 50N (e.g., about 1N) for an inlay having a surface area of about 0.5 mm² to about 10 mm² (e.g., 1.5 mm² to about 5 mm², and in one example, about 2.25 mm²). When the antenna includes a bulk aluminum layer, the inlay may be pressed into the antenna (on the second substrate) with a heated pressing tool. Thus, optionally, heating may be applied simultaneously with the pressure to the first and second substrates using a thermal head. The target temperature generally depends on the substrate materials, but can generally be from 50° C. to about 400° C. For example, when using a PET substrate, a maximum temperature of 190° C. should be used. However, 190° C. may also be a minimum temperature for curing certain epoxy sealants and/or adhesives.

The present method can be applied broadly to all wireless tags, including HF and NFC tags operating at 13.56 MHz, RFID tags operating at frequencies higher or lower than 13.56 MHz (especially where the RFID tag has the ability or functionality to accept external sensor input(s) and communicate the same when read by an RFID reader adapted to read such a tag), HF, VHF, or UHF tags, EAS tags, etc.

### Exemplary Wireless (e.g., NFC and/or RF) Device(s) and Intermediates in an Exemplary Process for Manufacturing the Same

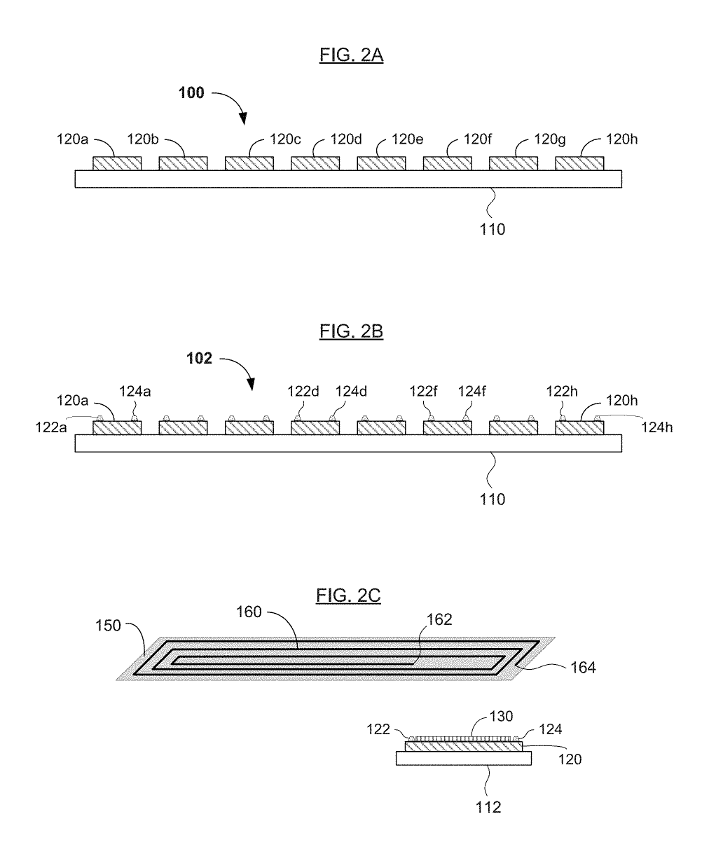

FIGS. 2A-C show cross-sectional views of exemplary intermediates in an exemplary process for making an exemplary wireless tag with printed stud bumps, and FIG. 2D shows the exemplary wireless tag, in accordance with one or more embodiments of the present invention. The wireless tag generally includes first and second substrates, an integrated circuit on the first substrate, printed stud bumps on input and/or output terminals of the integrated circuit, and an antenna on the second substrate. The integrated circuit is configured to (i) process a first wireless signal and/or information from the first wireless signal, and (ii) generate a second wireless signal and/or information for the second wireless signal. The antenna is electrically connected to the printed stud bumps and is configured to receive the first wireless signal and transmit or broadcast the second wireless signal. This wireless tag architecture is also applicable to radio frequency (RF) devices such as RFID tags, HF devices such as roll readers, VHF or UHF communication devices, EAS tags/devices, etc.

FIG. 2A shows a first substrate 110 having integrated circuits 120a-120h formed thereon. In various embodiments, the first substrate 110 comprises a metal foil. In one example, the metal foil comprises a stainless steel foil. Alternatively, the first substrate may comprise a plastic film or a glass sheet or slip, as described herein. In some embodiments, the integrated circuits 120a-120h may include one or more printed layers. Such layers have characteristics of printed materials, such as greater dimensional variability, a thickness that varies (e.g., increases) as a function of distance from the edge of the printed structure, a relatively high surface roughness, etc. Additionally and/or alternatively, the integrated circuits 120a-120h may (further) comprise one or more thin films (e.g., a plurality of thin films). Generally, the integrated circuits 120a-120h comprise a receiver and/or transmitter, in which the transmitter comprises a modulator configured to generate the wireless signal to be broadcast, and the receiver comprises a demodulator configured to convert the received wireless signal to one or more electrical signals (e.g., to be processed by the integrated circuits 120a-120h).

In exemplary embodiments, input and/or output terminals (not shown) may be formed in an uppermost metal layer of the integrated circuits 120a-120h. In various embodiments, the input and/or output terminals on the integrated circuits for printing the stud bumps thereon may include antenna connection pads (not shown). The antenna connection pads may comprise aluminum, tungsten, copper, silver, etc., or a combination thereof, and may have one or more barrier and/or adhesion-promoting layers thereon. For example, the antenna connection pads may comprise a bulk aluminum layer with a thin tungsten adhesion and/or oxygen barrier layer thereon.

FIG. 2B shows printed stud bumps 122a-h and 124a-h on opposing sides or ends of the integrated circuits 120a-120h. In various embodiments, at least two stud bumps (e.g., 122a and 124a) are on each integrated circuit (e.g., 120a). Preferably, the stud bumps include a first stud bump 122a-h on a first antenna connection pad of each of the integrated circuits 120a-h and a second stud bump 124a-h on a second antenna connection pad of each of the integrated circuits 120a-h. The first stud bump 122a-h may be at a first end of the integrated circuit 120a-h, and the second stud bump 124a-h may be at a second end of the integrated circuit 120a-h opposite the first end.

In some embodiments, the printed stud bumps 122a-h and 124a-h include (i) a solder alloy comprising tin and one or more alloying elements selected from bismuth, silver, copper, zinc, and indium, and (ii) an adhesive resin material. The alloying element(s) may depend on the material and/or type of antenna or pad being used. For example, tungsten, stainless steel, and copper antenna connection pads may require or benefit from higher processing temperatures, and can therefore include an alloying element (e.g., silver or copper) that provides the solder with a higher reflow temperature. Aluminum pads may be successfully processed at relatively low temperatures (e.g., at 210° C.), and therefore, alloying elements that provide the solder with a reflow temperature of 210° C. or less such as bismuth, zinc and/or indium may be selected. Tin alloy bumps and noble metal pads (e.g., silver, gold, copper) typically work relatively well together. Thus, a thin copper layer (e.g., an adhesive or barrier layer) on aluminum pads may work relatively well, especially for smart tags (e.g., requiring or benefiting from a particular minimum Q).

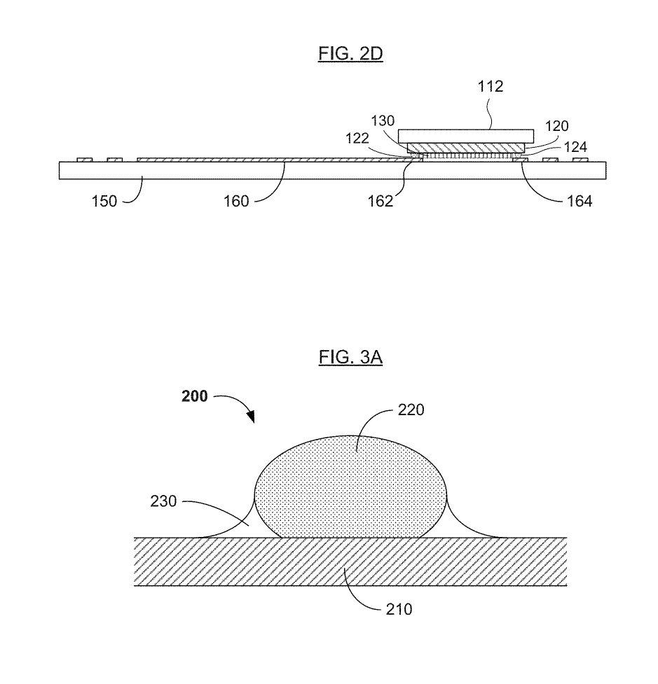

FIG. 3A shows an exemplary stud bump 200, comprising a solder ball 220 and an adhesive resin material 230 on an input and/or output terminal (e.g., an antenna pad) 210. The stud bump 200 is shown after reflow, in which the adhesive resin material 230 segregates out of the printed solder resin and forms an adhesive layer surrounding the lower half on the solder ball 220. In some embodiments, a stud bump 200′ (FIG. 3B) may further comprise an underbump layer 240 on the input and/or output terminals 210. The underbump layer 240 may comprise one or more conductive and/or metal layers (e.g., Cu, Ni, Pd, Au, graphene, carbon nanotubes, etc.) that are resistant to forming an oxide. Thus, the underbump layer 240 may help to prevent formation of an oxide on the input and/or output terminals (e.g., the antenna pads) 210. When the underbump layer comprises Au, the Au may dissolve into the solder in the stud bump.

In various embodiments, the printed stud bumps have a predetermined size and shape. For example, the printed stud bumps may have a bump, half-circle, dome, cone, plateau, “bread loaf,” or mushroom cap shape. Also, the stud bumps may have a thickness or height of about 50 μm to about 300 μm (e.g., about 100 μm, or any other value or range of values therein). In general, the resin comprises an epoxy resin.

FIG. 2C shows an integrated circuit 120 on a singulated first substrate 112, along with an antenna 160 on a second substrate 150, prior to attachment. In some embodiments, the second substrate 150 may comprise a PET film or sheet. In various embodiments, the antenna 160 may consist of a single metal layer on the second substrate 150.

In various embodiments, the antenna 160 may be a printed antenna (e.g., using printed conductors such as, but not limited to, silver from a silver paste or ink) or a photolithographically-defined and etched antenna (e.g., formed by sputtering or evaporating aluminum on a substrate such as a plastic film or sheet, patterning by low-resolution [e.g., 10-1,000 μm line width] photolithography, and wet or dry etching using the patterned photolithography resist as a mask). The antenna 160 may have a size and shape that matches any of multiple form factors, while preserving compatibility with the target frequency or a frequency specified by one or more industry standards (e.g., the 13.56 MHz target frequency of NFC reader hardware).

An adhesive 130, such as anisotropic conductive paste (ACP) or non-conductive paste (NCP), is dispensed on the integrated circuit 120 in areas other than the antenna connection pads under stud bumps 122 and 124. An NCP generally improves resistance between integrated circuit 120 and antenna 160, thereby improving the quality of the wireless communication device. Thus, generally, a non-conductive adhesive is used. For example, the adhesive 130 may comprise an epoxy adhesive. Typically, the epoxy adhesive 130 is dispensed on the bump side of the inlay (i.e., integrated circuit 120 on substrate 112), between the inlay and antenna, and the antenna is secured to with the epoxy adhesive 130.

FIG. 2D shows the final product in which the antenna 160 is attached to the integrated circuit 120, such that a first end 162 of the antenna contacts and is electrically connected to the first printed stud bump 122, and a second end 164 of the antenna contacts and is electrically connected to the second printed stud bump 124 on the opposite side of integrated circuit 120. Methods of placing the antenna 160 on or over the integrated circuit 120 include, but are not limited to, pick-and-place or roll-to-roll processing. Methods of attaching the antenna 160 to the integrated circuit 120 include, but are not limited to, crimping, applying an ACP on the plurality of stud bumps, applying pressure to the antenna 160 and the integrated circuit 120, or applying pressure and heat to the antenna 160 and the integrated circuit 120.

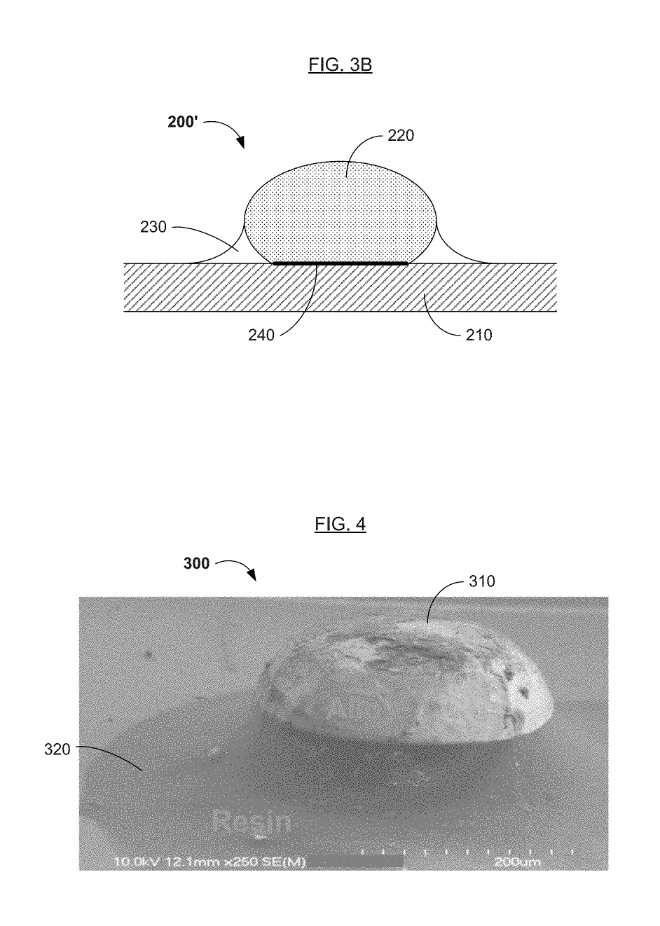

FIG. 4 shows an exemplary printed stud bump 300, in accordance with one or more embodiments of the present invention. The printed stud bump 300 includes solder alloy ball 310 and a resin 320. In the example of FIG. 4, the stud bump 300 was screen-printed using SAM10, a SAAS available from Tamura Corporation. The resin 320 covers the lowermost portion (e.g., about half) of the solder ball 310. Stud bumps 300 form excellent contacts to aluminum or copper-plated aluminum antennas by pressure (e.g., crimping) alone. Simultaneous application of heat (e.g., up to about 190° C.) further facilitates ohmic contact between the stud bumps 300 and the antenna.

Printing stud bumps on the integrated circuit advantageously reduces the cost and processing time of wireless tags and increases the scalability of the manufacturing process. In addition, the present invention process also significantly reduces the cost of the processing the bumps.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application. It is intended that the scope of the invention be defined by the claims appended hereto and their equivalents.

1. A method of manufacturing a wireless communication device, comprising:
a) forming an integrated circuit on a first substrate;
b) printing stud bumps on input and/or output terminals of said integrated circuit;
c) forming an antenna on a second substrate, said antenna being configured to (i) receive and (ii) transmit or broadcast wireless signals; and
d) electrically connecting ends of the antenna to said stud bumps.

2. The method of claim 1, wherein said wireless communication device comprises a near field, radio frequency, high frequency (HF), very high frequency (VHF), or ultra high frequency (UHF) communication device.

3. The method of claim 1, wherein forming the integrated circuit comprises printing one or more layers of the integrated circuit.

4. (canceled)

5. (canceled)

6. (canceled)

7. The method of claim 1, further comprising forming said input and/or output terminals in an uppermost metal layer of said integrated circuit.

8-13. (canceled)

14. The method of claim 1, wherein the stud bumps comprise a first stud bump on a first input and/or output terminal and a second stud bump on a second input and/or output terminal.

15. (canceled)

16. The method of claim 1, wherein printing the stud bumps comprises printing a material comprising a solder and an adhesive resin on the input and/or output terminals.

17-23. (canceled)

24. The method of claim 1, further comprising forming an underbump layer on the input and/or output terminals prior to printing the stud bumps, wherein the underbump layer comprises one or more conductive materials that are resistant to forming an oxide in air having a relative humidity or 50% or less, at 25° C. and 1 atm pressure.

25-29. (canceled)

30. The method of claim 1, wherein the antenna consists of a single metal layer on the second substrate.

31. The method of claim 1, wherein electrically connecting the ends of the antenna to the stud bumps comprises placing the antenna on or over the integrated circuit, and connecting (i) the first end of the antenna to the first stud bump on the integrated circuit and (ii) the second end of the antenna to the second stud bump on the integrated circuit.

32. (canceled)

33. (canceled)

34. A wireless communication device, comprising:
a) a first substrate;
b) an integrated circuit on said first substrate, said integrated circuit being configured to (i) process a first wireless signal and/or information therefrom, and (ii) generate a second wireless signal and/or information therefor;
c) printed stud bumps on input and/or output terminals of said integrated circuit;
d) a second substrate; and
e) an antenna on said second substrate, wherein said antenna is electrically connected to said stud bumps, and is configure to receive said first wireless signal and transmit or broadcast said second wireless signal.

35. The device of claim 34, wherein the device is a near field, radio frequency, high frequency (HF), very high frequency (VHF), or ultra high frequency (UHF) communication device.

36. The device of claim 34, wherein the integrated circuit comprises a receiver and a transmitter.

37. (canceled)

38. (canceled)

39. The device of claim 34, wherein said first substrate comprises a metal foil and/or the second substrate comprises a plastic.

40. (canceled)

41. (canceled)

42. (canceled)

43. The device of claim 34, wherein the integrated circuit comprises one or more printed layers.

44. (canceled)

45. The device of claim 34, wherein the integrated circuit comprises one or more thin films.

46. (canceled)

47. The device of claim 34, wherein said input and/or output terminals are in an uppermost metal layer of said integrated circuit.

48. The device of claim 34, wherein said input and/or output terminals comprise antenna connection pads, and the stud bumps are on or over the antenna connection pads.

49-52. (canceled)

53. The device of claim 34, wherein the stud bumps comprise a first stud bump on a first input and/or output terminal and a second stud bump on a second input and/or output terminal.

54. (canceled)

55. (canceled)

56. (canceled)

57. The device of claim 34, further comprising an underbump layer on the input and/or output terminals, and the underbump layer comprises one or more conductive materials that are resistant to forming an oxide in air having a relative humidity or 50% or less, at 25° C. and 1 atm pressure.

58. (canceled)

59. (canceled)

60. The device of claim 34, wherein the antenna consists of a single metal layer on the second substrate.
